(19) United States
(12) Patent Application Publication
(10) Pub. No.: US 2015/0081400 A1
(43) Pub. Date: Mar. 19, 2015

(54) Watching ARM

(71) Applicant: INFOSYS LIMITED, Bangalore (IN)

(72) Inventor: Pradeep John, Kottayam (IN)

(73) Assignee: INFOSYS LIMITED, Bangalore (IN)

(21) Appl. No.: 14/489,401

(22) Filed: Sep. 17, 2014

(30) Foreign Application Priority Data
Sep. 19, 2013 (IN) 4212/CHE/2013

(51) Int. Cl. G06Q 10/06; G06F 9/445; G06F 17/30

(52) U.S. Cl. CPC G06Q 10/0639; G06F 17/30876; G06F 8/61
USPC 705/7.38

(57) ABSTRACT

Improving operation stability and system availability of the IT systems at low costs is a primary objective of IT department of any customer. Implementing a one stop solution to monitor the system availability, to identify critical incidents in the systems before it becomes service impacting, to have a consolidated configuration management database, to measure the application performance on a business perspective, to have IT operations dashboard to provide statistics for capacity management and to provide detailed analysis by means of trending is a critical success factor in improving the system availability and operation stability of IT systems. Watching Application and Resource Management (ARM) is a comprehensive tool based solution to monitor and address the major areas of business requirements from IT systems and brings out visibility to realize the Operational Stability and System Availability.

### FIELD

The field relates to a tool based solution to monitor and analyze the performance of information technology network and measure its impact on the business requirements and functions.

### BACKGROUND

A multi-tier architecture in an information technology network, which is often referred as n tier architecture, is an integrated system wherein each of the components of the multi-tier architecture handles specific aspect related to a data that flows across the entire architecture. For instance, increasingly enterprise applications have been implemented with a multi-tier architecture that has a web server that interfaces the user, an application server that hosts the enterprise management application and data warehousing servers that ensure data handling and security of data. However, in such multi-tier architecture, it becomes increasingly difficult to trace and track the performance of each of the components of the architecture, which impacts the overall performance of the information technology network in view of the business requirements of an organization. The present invention technique is capable of monitoring and analyzing performance of the components of an information technology network and identify the cause of poor performance quality in a given multi-tier information technology network.

Also, in view of a multi-tier information technology network, middleware is generally employed to enable communication and management of data, but there is a dearth of tools that provides a functionality to monitor the performance of the middleware itself. The present technique addresses this issue by enabling a user to assess middleware performance.

### SUMMARY OF INVENTION

The present technique when implemented provides for monitoring and analyzing the performance of such complex multi-tiered and distributed information technology network system.

Embodiments of the present invention comprise a computer implemented system and a method for monitoring and analyzing the performance of user-defined processes and components in a multi-tiered and distributed information technology system. The present technique may be implemented for health check monitoring and trending, web logic monitoring, data warehouse job monitoring, managing critical incident and generating alerts, capacity management. In addition to monitoring the processes and components, the present system may be implemented to monitor Service Level Agreement (SLA) compliance, quality attributes in a service such as Right First Time (RFT) and other business data processed over the network.

These and other features, aspects and advantages of the present invention will become better understood with reference to the following description and appended claims.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 depicts an illustrative view of the Watching Application and Resource Management (ARM) tool, in accordance with an embodiment;

FIG. 2 depicts an a illustrative view of an information technology network that may be monitored by implementation of the present technique, in accordance with an embodiment;

FIG. 3 depicts and illustrative view of the business metrics monitored using the Watching ARM tool in accordance with an embodiment;

FIG. 4 depicts an illustrative critical network parameter monitored by the Watching ARM tool in accordance with an embodiment;

FIG. 5 depicts an illustrative view of network performance as a function of its components in accordance with an embodiment;

FIG. 6 depicts an illustrative view of network performance of a web server as a function of a sub component;

FIG. 7 depicts an illustrative view of the network performance of an application server as a function of sub-component;

FIG. 8 depicts an illustrative view of network performance as a function of incidents recorded of the information technology network in accordance with an embodiment;

FIG. 9 depicts an illustrative view of network performance of a database server as a function of a sub component;

### DETAILED DESCRIPTION

The system disclosed in the invention comprises a Watching ARM application designed to monitor, analyze and correlate information technology and business performance data. The Watching ARM architecture comprises of the Watching ARM application that may be installed on an application server, which may be accessed by a user through a web server. In addition to a web server and an application server that may host the Watching ARM application, a Watching ARM architecture may comprise of one or more database servers that stores configuration data, which is hereinafter referred as configuration management database, and the parameters monitored in the given information technology network.

In one of the illustrative scenarios, the Watching ARM tool may be implemented for monitoring and trending the performance of the information technology network. For instance, the present invention may be implemented for fetching and analyzing server health information such as CPU utilization, memory utilization, and disk utilization and application processes. Such details may be collected at a pre-configured time period for application servers and/or database and/or web servers. The information measured using Watching ARM clients may be collected in text files and then transferred to the Watching ARM database server using OpenSSH protocol. Parameters to be monitored and the thresholds for each of the defined parameters may be defined and modified in a configuration management database of the Watching ARM tool.

In another illustrative scenario, the Watching ARM tool may be implemented for web logic monitoring. The Watching ARM clients may be installed to monitor web logic nodes health information like JVM heap usage, Java connection pool status and usage, node status and thread usage. Such details may be collected at a pre-configured time interval for application servers and/or database and/or web servers. The information measured using Watching ARM clients may be collected in text files and then transferred to Watching ARM database server using OpenSSH protocol. Parameters to be monitored and the thresholds for each parameter may be defined and modified in the configuration management database of the Watching ARM tool.

Another implementation of the present invention may be data warehouse job monitoring. Data warehousing job information like the run date, start and end time of the job and SLA compliance information may be collated and analyzed by the Watching ARM tool. In one of the preferred implementations, such information may be collated using SQL scripts that may interact with the Watching ARM tool database server using SQLPLUS or OSQL utility. In one of the preferred embodiments, the Watching ARM tool database may be an Oracle® database and the preferred webserver for the Watching ARM tool may be a Microsoft Internet Information Server.

The Watching ARM tool may be integrated with incident monitoring systems. The category and the type of incidents and the threshold limits for each of them may be defined in the configuration management database of the Watching ARM tool. Based on the pooled data from the incident monitoring systems and the configuration defined in the configuration management database of the Watching ARM tool, an alert may be triggered to notify the network administrator.

It is therefore an object of the present invention to provide a system and a method of a unified platform for monitoring, measuring and assessing the performance of the information technology network and its components. The Watching ARM tool of the present invention technique may be implemented to have a comprehensive statistics on devices, programs and application performance in an information technology network.

The following description is full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

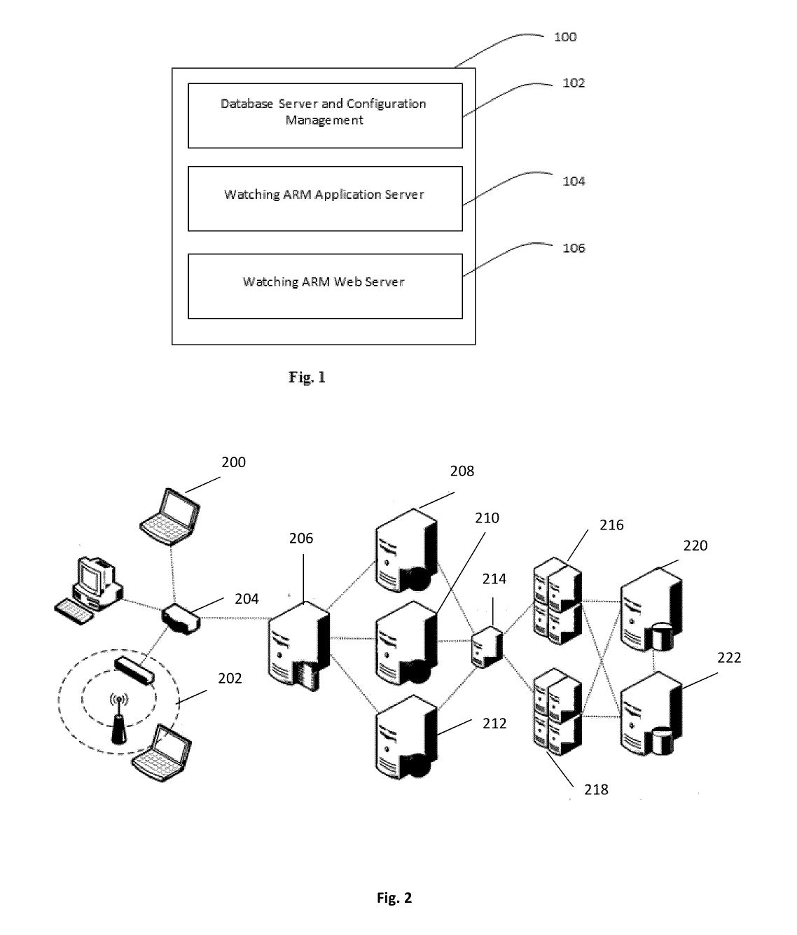

FIG. 1 presents an illustrative view of the architecture of the Watching ARM architecture 100. The architecture may comprise at least one database and configuration management server 102, an application server 104 on which the Watching ARM tool may be installed and a web server 106 through which a user may interact with the Watching ARM tool. As represented in FIG. 1, in a non-limiting illustration, a user of a Watching ARM tool may use a device such as laptop, a desktop or any hand-held device to login into the Watching ARM tool. The device may be connected to a web server over a network which may include an internet, an intranet, a LAN, or any other wireless connection. The webserver 104 may be connected to an application server 104 that may be primarily responsible to execute the query logged by a user using a web server 106. The database server 102 may have a dual functionality in terms of storing the user defined configuration parameters that need to be monitored on one or more devices in an information technology network and storing the measured data using clients installed on the devices in an information technology network. While implementing the present technique, the user may specify one or more parameters that may be monitored for a given application, a device or a middleware in an information technology network and the monitored parameters may be recorded in a database server 102.

In one of the preferred embodiments of the present invention, the present invention may be implemented to monitor a host of applications related to procurement. The information technology network hosting the application may have a three tier architecture that may has at least one application server, one or more web servers and at least one database server hosted on three different physical servers. The challenge in such an implementation may be to effectively monitor and measure the performance of the hosted applications, middleware that enables connection between the physical servers and several other processes that are being performed on different servers or devices, but impacts the overall business activity of order management. In a non-limiting example, the present technique when implemented enables health check monitoring and trending, middleware monitoring and trending and provides detailed business metrics to evaluate the performance of the information technology network. The multi-tier deployment of such architecture is presented in FIG. 2. The multi-tier deployment may include devices including laptop, desktops, hand-held devices 200 associated with the employees of an organization. In one of the implementations of the present technique, the employees may be located over different geographic locations and may interact in the multi-tier architecture over network 202 with a business enterprise application. Using devices 200, an employee may connect to webservers 208, 210 and 212 through network 202 using a router 204 and a proxy server 206. In a preferred embodiment, the information technology network may employ a load balancer 214. The application servers 216, 218 host App1 that may handle quoting, proposal and ordering, while provisioning may be handled App2. App3 may handle billing and customer complaints may be managed by App4 hosted on the application servers 216 and 218. Through devices 200, an employee may interact with these applications hosted on application servers 210 through the webservers 208, 210 and 212. The data logged by the user during his or her interaction with the applications installed on the application server may then be stored in database servers 220 and 222. Since the data logged by the user in any one of the applications may flow on to the next stage to another application or a server, job monitoring and middleware performance management to ensure data integrity is essential. The present invention technique may be implemented to measure, evaluate and correlate application and infrastructure performance to overall business activities.

A Watching ARM administrator may employ the present invention technique to monitor, measure, and analyze the performance of the parameters critical to business activities. In one of the preferred embodiment, a Watching ARM administrator may identify availability or any other performance benchmark of the servers in the system as a critical parameter to be monitored and analyzed. A Watching ARM administrator may define availability of the servers or any such performance benchmark as a critical component in the database server 102 of the Watching ARM architecture as depicted in FIG. 1. The availability or any such performance benchmark may have specific events or parameters that may impact the availability or performance of the servers in the information technology network. For instance, the information technology network may be monitored for CPU, memory and disk usage, which may be configured as the parameters to be monitored using Watching ARM clients over the information technology network. The clients deployed using the Watching ARM application to measure the CPU, memory and the disk usage may be customized as the part of the Watching ARM application. In yet another preferred embodiment, a Watching ARM administrator may deploy standardized ticketing tools such as Radix® or Remedy® to monitor any disk capacity, CPU, memory issues, router failure instances, or any other specific issue or parameter that may be configured in the database and configuration management server 102. The application servers 216 and 218 may be monitored for application performances and availability that may involve monitoring application processes and middleware performance that may be deployed to process the queries or data logged by a user using devices 200 over the information technology network. The database servers 220 and 222 may involve job monitoring, purging job history and SLA achievements. A Watching ARM administrator may define such parameters to be monitored in the configuration management and database server 102 as depicted in FIG. 1. In addition, the Watching ARM administrator may install specific clients on each of these servers that may be customized to monitor and analyze the configured parameters over the information technology network. In a preferred embodiment, these clients may be customized for compatibility to Microsoft®, Unix® or Linux® environment. The administrator may opt to install such clients on each of the servers remotely. In a preferred embodiment, clients installed on each of the components of the information technology network may be remotely installed. Additionally, the data on incidents monitored and measured using such clients or ticketing tools may be transferred to the database server of the Watching ARM application using OpenSSH protocol. In yet another embodiment, the in the configuration database, a threshold limit of such incidents may be predefined by the user. In another preferred embodiment, clients deployed to monitor and measure the configured parameters or processes on database servers 220 and 222 may be transferred to the data base server of the Watching ARM application using SQLPLUS or OSQL utilities.

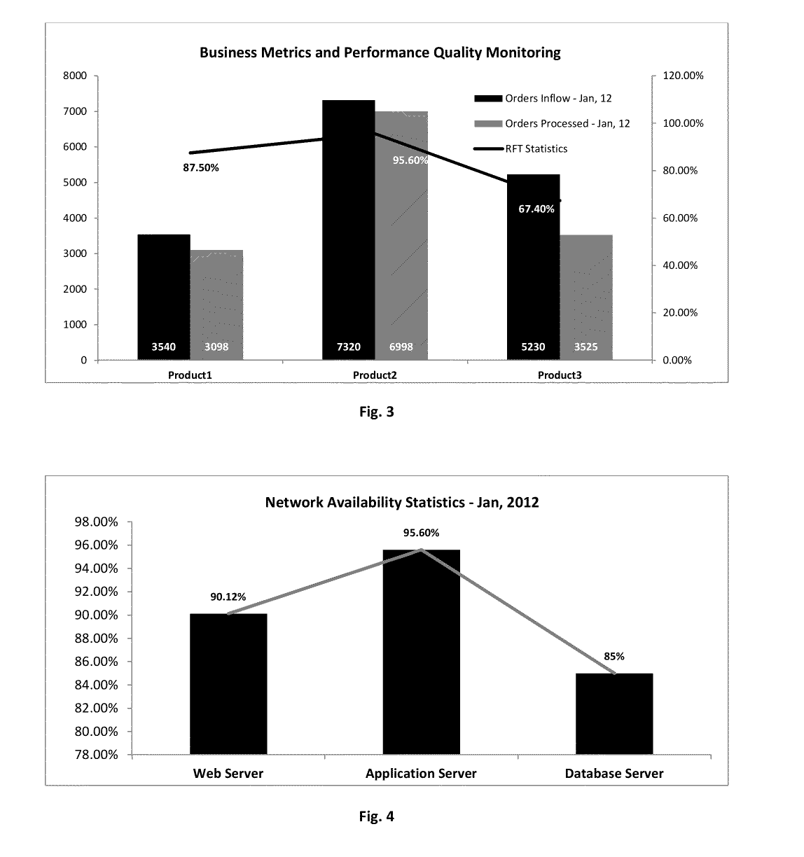

FIG. 3 depicts and illustrative view of the business metrics monitored using the Watching ARM tool in accordance with an embodiment. The Watching ARM tool may be implemented to monitor the information technology network that enables procurement practice for multiple products. With Watching ARM clients installed on each of the servers, a user may monitor the number of orders received across each product or product category and estimate the Right First Time (RFT) statistics and measure SLA compliance. FIG. 3 represents a slump in RFT for product3 related orders for the given time frame. The description of subsequent figures provides an illustrative view of implementation of Watching ARM tool to generate an insight into the root cause of such subdued business performance.

FIG. 4 depicts an illustrative critical network parameter, which is availability of the servers in the information technology, monitored by the Watching ARM tool in accordance with an embodiment. In the preferred embodiment, the web servers 208, 210, and 212, application servers 216 and 218 and the database servers 220 and 222 forms the components of the information technology network monitored for its performance since it has a significant impact on the business performance. Various other parameters that affect the availability of these servers in the given information technology network have been hereinafter referred as components of the system. The Watching ARM clients installed on these servers may monitor availability of each of these elements and provide an overview of the performance of each of the network devices or servers on a dashboard in view of bar charts as represented.

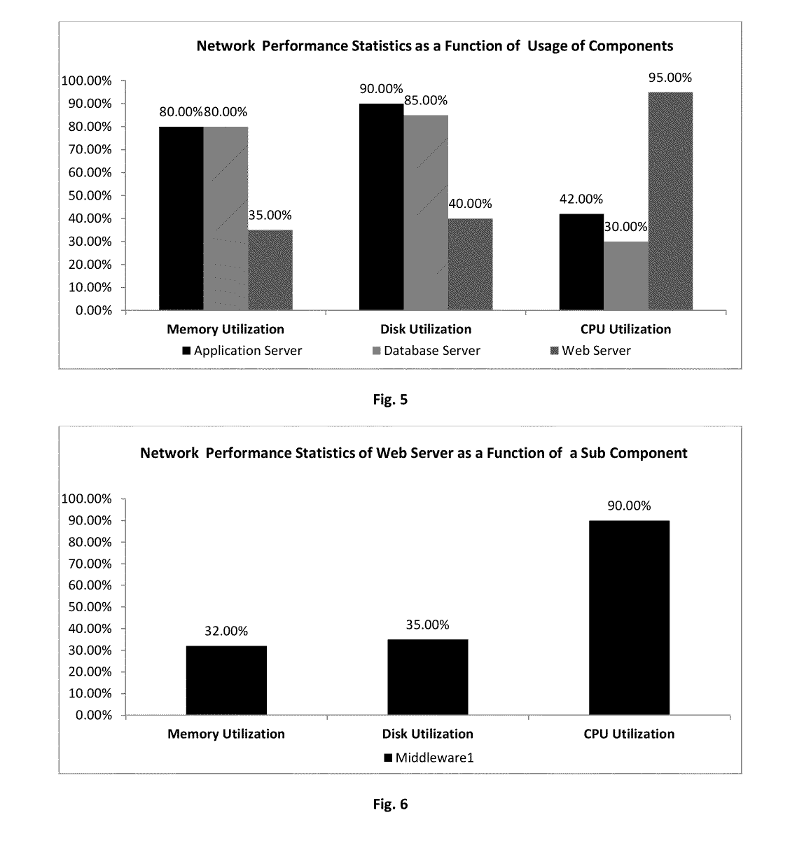

FIG. 5 depicts an illustrative view of network performance as a function of its components in accordance with an embodiment. The utilization of memory, CPU and disk space may impact the availability and hence, the business performance in a multi-tier information technology architecture. A user may define utilization of memory, CPU and disk as the parameters to be monitored for each of the servers in the configuration management database of the Watching ARM tool. The monitoring of utilization of memory, CPU and disk may enable the tool to estimate the availability. For instance, in the given embodiment, the web server experiences extremely high utilization and hence, may tend to lower the availability of the server. However, the utilization of memory, CPU and disk on these servers may be further impacted by other processes or middleware or application that may use these components. These processes or middleware or application are hereinafter referred as sub components of the network.

FIG. 6 depicts an illustrative view of network performance of a web server as a function of a sub component. In the preferred embodiment, a user may choose to monitor a subcomponent—Middleware1 on the web server for estimating the utilization of the components that impacts the availability. The Watching ARM clients installed on the webserver to monitor the utilization by a process or a sub component such as Middleware1 may be customized and/or remotely installed on the web server. FIG. 6 highlights that Middleware1 installed on the webserver may be adversely affecting the availability due to extremely high utilization.

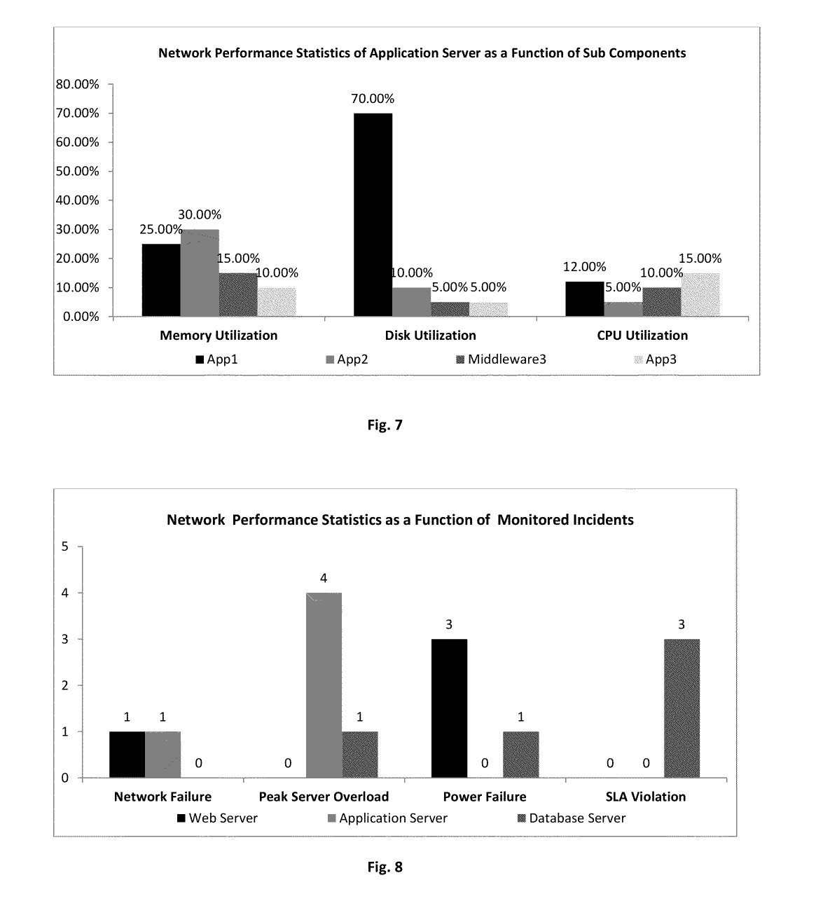

FIG. 7 depicts an illustrative view of the network performance of an application server as a function of sub-component. In the preferred embodiment, a user may choose to monitor App1, App2, Middleware3 and App3 installed on the application server. FIG. 7 highlights that App1 has extremely high disk utilization compared to any other application, process or middleware installed and monitored on the application server. Such an instance may provide an opportunity to a user to customize and alter mechanisms in App1 to lower disk utilization.

FIG. 8 depicts an illustrative view of network performance as a function of incidents recorded of the information technology network in accordance with an embodiment. The Watching ARM tool may be configured to receive incidents related data from standard ticketing tools such as Radix® or BMC Remedy®. FIG. 8 highlights Peak Server Overload as one of the concerns with the application server, while the web server may be afflicted with issues related to power failure. It also depicts SLA violation being recurrently reported on the database servers.

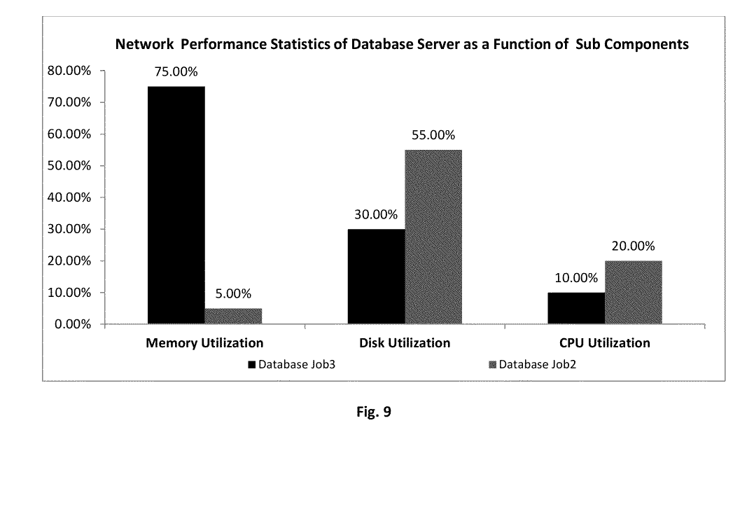

FIG. 9 an illustrative view of network performance of a database server as a function of sub components. The implementation of the Watching ARM tool may enable a user or network administrator to identify the memory utilization on the database server being extremely high in the preferred embodiment owing to Databasejob3, which may also involve job monitoring.

While, the following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest cope consistent with the principles and features described herein.

Many modifications of the present invention will be apparent to those skilled in the arts to which the present invention applies. Further, it may be desirable to use some of the features of the present invention without the corresponding use of other features.

Accordingly, the foregoing description of the present invention should be considered as merely illustrative of the principles of the present invention and not in limitation thereof.

1. A method of integrating business data and information technology performance data over an information technology network comprising:
configuring one or more parameters to be monitored in a database in a server;
installing one or more client applications on a device connected over the information technology network to monitor the said one or more configured parameters related to business and information technology (IT) performance;
transmitting the monitored data from the said devices to the server; and
analyzing by a client application on the server the transmitted business and the information technology performance data.

2. The method of claim 1 wherein one or more of the monitored parameters characterize device heath, middleware performance, and business data.

3. The method of claim 1 wherein the analyzing comprises reporting system availability and operational stability.

4. The method of claim 1 wherein the analyzing includes a measure of service level agreement (SLA) compliance.

5. The method of claim 1 wherein the client applications are installed remotely.

6. The method of claim 1 wherein the transmitting of the monitored data to the server is done using an Open SSH protocol.

7. The method of claim 1 wherein a correlation between the business data and operational data is presented in a graphical or textual or a combination of both.

8. The method of claim 1 wherein the server includes an Internet Information Server that interfaces and authenticates a user to the client application on the server.

9. The method of claim 1 wherein the information technology performance data is obtained from one or more ticketing tools to monitor and report critical incidents or events over the information technology network.

10. The method of claim 1 wherein the one or more client applications are for job monitoring on one or more data warehousing servers.

11. The method of claim 10 wherein communication between the server and the plurality of data warehousing servers is performed using an SQLPLUS or an OSQL utility.

12. A system to integrate business and information technology performance data over an information technology network comprising:
a database in the server that contains information on configuration of one or more parameters to be monitored using one or more clients, wherein the client is an application for monitoring and collecting of data related to the configured parameters;
a plurality of devices in the information technology network connected over a network to the server, wherein device specific clients are installed on the said devices to monitor and transmit data related to the configured parameters;
one or more client applications installed on a plurality of data warehousing servers for job monitoring;
a client application on the server that analyzes the business data and the information technology performance data transmitted to the server from the devices and the data warehousing servers.

13. The system of claim 12 wherein the information technology performance data is obtained from one or more ticketing tools interfaced with the server to monitor and report critical incidents or events over the information technology network.

14. The system of claim 12 wherein the plurality of devices communicate with the server using an OpenBSD Secure Shell (Open SSH) protocol.

15. The system of claim 12 wherein the clients installed on the devices are customized to monitor and measure one or more parameters.

16. The system of claim 12 wherein the clients are installed remotely.

17. The system of claim 12 wherein a client application is installed in a Microsoft ® Windows® or UNIX® environment.

18. The system of claim 11 wherein communication between the server and the plurality of data warehousing servers is performed by means of an SQLPLUS or an OSQL utility.

19. The system of claim 13 wherein a threshold limit of the incidents or events monitored by the ticketing tools is defined in the database in the server.

20. A computer-implemented method of integrating business data and information technology performance data over an information technology network comprising:
a database in the server that contains configuration information of one or more parameters to be monitored using one or more client applications, wherein the client application is a used for monitoring and collecting data related to the configured parameters;
deriving data into the server from one or more client applications installed on the plurality of devices, wherein the data communication between the plurality of the devices and the server uses an OpenBSD Secure Shell (Open SSH) protocol;
deriving data into the server using one or more client applications installed on the data warehousing servers for job monitoring, wherein the data communication between the data warehousing servers and the server uses SQL or OSQL utility;
deriving data from a plurality of ticketing tools wherein each tool is communicatively interfaced with the server;
analyzing by a client application on the server the measured business data and the information technology performance data, wherein analyzing involves optimizing the system performance and measuring the system availability.
